(19) United States
(12) Patent Application Publication
(10) Pub. No.: US 2018/0359214 A1
(43) Pub. Date: Dec. 13, 2018

(54) DEVICE AND METHOD FOR WIRELESS COMMUNICATION IN AN IP NETWORK

(71) Applicant: COMMISSARIAT A L'ENERGIE ATOMIQUE ET AUX ENERGIES ALTERNATIVES, Paris (FR)

(72) Inventors: Christophe JANNETEAU, Chaudon (FR); Michael BOC, Clamart (FR)

(21) Appl. No.: 15/781,687

(22) PCT Filed: Nov. 21, 2016
(86) PCT No.: PCT/EP2016/078332

§ 371 Date: Jun. 5, 2018

(30) Foreign Application Priority Data
Dec. 7, 2015 (FR) 1561933

(51) Int. Cl. H04L 29/12; H04W 76/15; H04W 28/20

(52) U.S. Cl. CPC H04L 61/2514; H04L 61/2521; H04W 28/20; H04W 76/15; H04L 61/256

(57) ABSTRACT

A device is provided for communication in an IP network to significantly increase the bandwidth available for wireless communications between user terminals and their correspondents in the IP network. The device operates as aggregation router which, via a single network interface, to allocate the received datastreams to different wireless routers configured according to a so-called aggregate router mode systematically using a network address translation (NAT) mechanism for any traffic routed between the LAN and WAN interfaces, and to allow the connected terminals to benefit from the aggregate bandwidth of the aggregate wireless routers.

### FIELD OF THE INVENTION

The invention relates to the field of telecommunications, and in particular that of communications in IP networks such as the Internet.

### STATE OF THE ART

Many uses require the ability to connect to the internet network (or any other IP protocol Internet network) via a wireless connection, for example to access the Internet from a moving vehicle, or from a geographic zone not covered by a wired infrastructure such as ADSL connection. The access networks with wide coverage—wide area networks (WAN)—such as the cellular networks of 2G, 3G or 4G type, or the satellite networks, are means most commonly used to connect wirelessly to the Internet, through their wide geographic coverage. Moreover, in many cases, the need for wireless connection to the Internet does not concern just one equipment item such as a smartphone, but can relate to a plurality of equipment items forming a network. One common case in point is that of a vehicle (car, truck, bus, train, etc.) having to connect to the Internet network several of its own embedded equipment items or terminals or onboard equipment items. To address this need, it is known practice to use a wireless router. One example of wireless router commonly used is that of the smartphone configured according to the “connection sharing” mode. In this mode, the smartphone configures its Wi-Fi interface in access point (AP) mode to create a Wi-Fi access point to which other equipment items or terminals can connect. The smartphone can then route the IP communications of its third-party equipment items or terminals via its WAN interface to offer them access to the Internet.

FIG. 1 illustrates a communication environment (100) in an IP network via a wireless router (102). The wireless router (102) is composed of a WAN interface (104), for example a cellular interface of 2G or 3G or 4G type, to connect to the Internet, and one or more local interfaces—local area network (LAN)—for example an Ethernet interface (106) and/or a Wi-Fi interface (108), via which communicating terminals (110, 112) can connect to the wireless router (102) to connect to the Internet. The communicating terminals can be terminals of Ethernet (110) and/or Wi-Fi (112) type which have a corresponding Ethernet or Wi-Fi interface but do not need a WAN interface. The wireless router (102) routes the IP communications between the terminals and their correspondents in the Internet—correspondent node (CN)—by routing the IP data packets associated with these communications between the LAN and WAN interfaces and vice versa.

The wireless router is also composed of a TCP/IP communication protocol stack (114) which comprises components for performing the IP router function to route the data packets between the LAN and WAN interfaces, and the access router configuration function for each of the LAN (Ethernet and Wi-Fi) interfaces. The configuration of the router makes it possible to perform the functions of:
default routing (116) which allows the wireless router to be announced as a “default router” to the terminals (110, 112) connected to the LAN interface (106, 108). Through this function, these terminals can discover the IP address of the wireless router on the LAN interface and use the latter as their default router. Thus, any traffic transmitted by these terminals is systematically transmitted to the corresponding LAN interface (106, 108) of the wireless router. This function is based on standard protocols, DHCP—Dynamic Host Configuration Protocol for IPv4 (RFC 2131) or NDP—Neighbor Discovery Protocol for IPv6 (RFC 4861);
address provider (118) which allows the wireless router to provide an IP address to each of the terminals (110, 112) connected to the LAN interface. This function is based on one of the following standard protocols:
So-called “stateful” address configuration whereby the wireless router hosts a DHCP server managing a pool or set of IP addresses and allocates one or more addresses to a terminal acting as DHCP client on request from the latter, according to the DHCP for IPv4 DHCP for IPv6 protocol.
So-called “stateless” address configuration whereby the wireless router announces an addressing space (that is to say an IPv6 prefix) on its LAN interface and on the basis of which a terminal connected to this LAN interface can construct or self-configure a usable IPv6 address for itself, according to the IPv6 stateless address autoconfiguration protocol;
NAT (120), for “Network Address Translation”, which allows the wireless router to apply a change of source IP address upon the transfer of the IP packets over the WAN interface by introducing therein an IP address configured on this interface in order for the packet to be routable in the WAN and/or the Internet domain. In effect, generally, the IP addresses configured by the terminals connected to the LAN interfaces of the wireless router are so-called private addresses and therefore addresses that cannot be routed in the WAN network and the Internet. This NAT function also makes it possible, by using the TCP/UDP ports, to perform the reverse operation for the data packets incoming over the WAN interface by replacing the destination address of the packet with the private IP address allocated to the terminal connected to the LAN interface to which the packet is intended. More details on the NAT function can be found in RFC 3022.

In the very great majority of cases, the technologies used on the LAN interfaces offer bit rates well above those available on a WAN interface, with, as a very rough approximation, a LAN bit rate approximately 10 times higher than the WAN bit rate, for example 1 Gbps over an Ethernet LAN interface and up to several hundreds of Mbps over a Wi-Fi interface, when the bit rate at best these days reaches a hundred or so Mbps over a 4G WAN interface. Because of this, the WAN interface constitutes a bottleneck for all of the traffic transiting via a wireless router from or to terminals connected to its LAN interfaces. And, in practice, that limits the number of terminals and/or the quantity of traffic which can be routed via a wireless router. The quality of service or the quality of experience perceived by the users is therefore affected thereby.

To address this issue of limited bandwidth, induced by the use of a WAN interface of a wireless router, a first approach consists in equipping the wireless router with several WAN interfaces, to create a multiple-interface wireless router. This approach is fairly restrictive in practice because it requires both hardware and software extensions on the wireless router because new WAN interfaces have to be incorporated in the router, either directly therein (for example in the form of a PCI express mini card), or on external USB ports available on the router. These hardware extensions then induce a significant increase in the cost of the equipment while limiting the flexibility thereof because it remains difficult for the user to upgrade the number of WAN interfaces on his or her wireless router to adapt it to his or her own needs in terms of bandwidth. Furthermore, this approach also requires software extensions on the wireless router in order to take over the distribution of the different datastreams to the different WAN interfaces. There are various strategies for that:
so-called “backup link” strategy: in this case, just one of the WAN interfaces is used to route all the traffic. If the latter becomes unavailable, because of a loss of connectivity for example, then a new backup WAN interface is used to route the new streams (the streams previously routed over the first WAN interface being themselves interrupted). This strategy does not make it possible to increase the available bandwidth since only one WAN interface is active at a time;
so-called “load balancing/sharing” strategy: in this case, several WAN interfaces are used to route the different streams in order to distribute the overall load over the different interfaces.

Another known approach for addressing the issue of limited bandwidth induced by the use of a WAN interface of a wireless router consists in connecting a traffic source and/or destination terminal to several wireless routers, each being equipped with a WAN interface. However, this approach is fairly restrictive in practice because it requires both hardware and software extensions on the terminal itself. In particular:
in the case where the terminal uses the Ethernet technology, the latter can use only a single Ethernet interface to connect to the different wireless routers, which offers the advantage of not creating any hardware extension on the terminal. However, in this configuration, the terminal is exposed to several default routers, each wireless router being presented as a default router, which means providing software extensions on the terminal in order to take over the distribution of the different datastreams to the different default routers. This type of mechanism amounts in practice to selecting the source IP address to be used by the terminal for a particular datastream;
in the case where the terminal uses the Wi-Fi technology to connect to the different wireless routers, the terminal has to be equipped with as many Wi-Fi interfaces as there are wireless routers to which it wants to connect, because a Wi-Fi interface can be connected only to a single Wi-Fi access point at a time. That induces a significant increase in the cost of the terminal while limiting the flexibility of use thereof. Moreover, this approach also requires other software extensions on the terminal in order to take over the distribution of the different datastreams to the different interfaces, which in practice amounts to selecting the source IP address to be used by the terminal for a particular datastream.

Thus, whatever the LAN technology used (Ethernet or Wi-Fi), this second approach can create address conflicts since a terminal (110, 112) can be granted the same IP address by different wireless routers, the wireless routers allocating addresses in addressing spaces that are private, and therefore potentially identical from one router to another. Such is particularly the case when the wireless routers do not allow a user to configure the private addressing spaces that they use on their LAN interfaces, which is the case with some smartphones. In this address conflict situation, the mechanism that makes it possible to choose the wireless router associated with a datastream by the simple choice of source IP address is then no longer functional, which can create various consequences such as the duplication or the multiplication of the streams if they are taken over by two or more wireless routers and therefore a potential malfunction of the associated applications and a dissipation of the bandwidth. That can also have as a consequence a systematic routing of the streams to just one of the wireless routers, then no longer allowing to exploit the bandwidth of the other routers.

Finally, even if a user is given the possibility of manually configuring the different addressing spaces on his or her different wireless routers, that means, for him or her, an additional checking and configuration step which is tedious, complex and easily forgettable, therefore a complexity of use.

Thus, the known approaches present drawbacks which can be summarized as being:
risks of address conflicts at the user terminal level rendering the approach ineffective, even inoperative;
a complexity of use induced by the need to manually configure the addressing spaces on the wireless routers;
an increase in the cost of the user terminal or in the cost of the wireless router due to the required hardware extensions;
a limited flexibility of use due to the constraints on the maximum number of wireless routers that can be used as a function of the LAN interfaces really available on the terminal, and due to the software modifications necessary on all the terminals of the user.

There is then the need for a solution which overcomes the drawbacks of the known approaches. The present invention addresses this need.

### SUMMARY OF THE INVENTION

One object of the present invention is to propose a device that makes it possible to significantly increase the bandwidth available for wireless communications between a user terminal and its correspondent in an IP network.

The device of the invention is generally composed of one or more wireless routers coupled operationally to a router called “aggregation router” via a single network interface, allowing each user terminal connected to the aggregation router to communicate with its correspondent in an IP network, by benefiting from a greater bandwidth corresponding to the aggregate bandwidth of the different wireless routers.

Another object of the present invention is to propose a reliable and functional solution which eliminates any risk of address conflicts.

Another object of the present invention is to propose a solution which does not require any hardware modification to the wireless routers or to the user terminals, while allowing the use of any number of wireless routers by the device.

Advantageously, the device of the invention significantly increases the ease of use for a user, because no manual configuration of the addressing spaces of the wireless routers is required, the user terminals not being modified. Moreover, the user can easily add new wireless routers to the device to increase the available bandwidth without requiring any particular modification to the aggregation router, or modification of the correspondents in the Internet.

Advantageously, the aggregation mode on the aggregate wireless routers of the device of the invention can easily be implemented on any known wireless router, in the form of a software component to execute the required functions. Advantageously, the aggregation router requires only a single network interface.

The present invention will be advantageously applicable in all the environments where an equipment item of fixed or mobile user terminal type having a communication interface (LAN) interfaces with the Internet via another equipment item having a limited bandwidth, of wireless router type equipped with a WAN interface.

Advantageously, the device of the invention allows the “user terminal” equipment item to benefit from a greater bandwidth that can approach the maximum bit rate of its LAN interface by aggregating the bit rate of several WAN interfaces, the aggregate bandwidth corresponding to the sum of the bandwidths of the WAN interfaces of the wireless routers that are configured in aggregation mode.

Without being limiting, the examples of advantageous application of the present invention may be in the following scenarios:
“Box” scenario for increasing the bandwidth of a fixed communication box having only a single WAN interface (of Ethernet/ADSL, or fiber optic type). The increase in bandwidth can be produced by the use of additional WAN interfaces supplied by roaming equipment items of the users of the box such as smartphones having a WAN connection.
“Car” or “public transport” scenario for increasing the bandwidth of a mobile communication box deployed in a car or a public transport vehicle (e.g. bus, train, etc.) and having only a limited number of WAN interfaces (for example a “2G/3G/4G” interface, a “Wi-Fi” interface and a “802.11p” interface), even having no interface. The increase in bandwidth can be produced by the use of additional WAN interfaces provided by roaming equipment items of the driver or of the passengers of the vehicle such as smartphones having a WAN connection. The increase in bandwidth can also be produced by the use of communication boxes equipped with a WAN interface which will be fixedly incorporated in the vehicle. Such a scenario can be likewise extended to the “public safety” of police, fire brigade, ambulance vehicles, or even for “logistics” or the “industrial vehicle” field.

To obtain the results sought, a device as described in the independent claim 1 is proposed. In particular, there is proposed, a device for wireless communications in an IP network having a plurality of wireless routers capable of routing datastreams, each router having at least one LAN interface for receiving datastreams from at least one user terminal and a WAN interface for communicating to the IP network, the device comprising:
a router discovery module for identifying, among the plurality of wireless routers, a subset of routers, called aggregate routers, systematically using a network address translation (NAT) mechanism for any traffic routed between its LAN and WAN interfaces;
a stream allocation module capable of selecting, for a received datastream, an aggregate router among said aggregate routers and allocating the datastream to it; and
a single network interface, called aggregation interface, configured to receive datastreams from user terminals and to transmit each received datastream to the aggregate router which is allocated to it.

The invention also covers a method as described in the independent claim 18 to operate wireless communications in an IP network having a plurality of wireless routers capable of routing datastreams, each router having at least one LAN interface for receiving datastreams from at least one user terminal and a WAN interface for communicating to the IP network, the method comprising the steps of:
receiving a datastream from a user terminal;
identifying, among the plurality of wireless routers, a subset of routers, called aggregate routers, systematically using a network address translation (NAT) mechanism for any traffic routed between its LAN and WAN interfaces;
selecting an aggregate router from the subset of aggregate routers to allocate the received datastream to it; and
transmitting the received datastream to said selected aggregate router.

All or part of the invention can operate in the form of a computer program product which comprises code instructions to perform the steps of the method claimed when the program is run on a computer.

### DESCRIPTION OF THE FIGURES

Different aspects and advantages of the invention will become apparent in support of the description of a preferred, but nonlimiting, mode of implementation of the invention, with reference to the figures below:

FIG. 1 shows a communication environment using a wireless router;

FIG. 2 illustrates a communication environment using a wireless router and an aggregation router in a first embodiment of the invention;

FIG. 3 illustrates a communication environment using a wireless router and an aggregation router in a second embodiment of the invention;

FIG. 4 shows a sequence of steps for routing a datastream in an embodiment of the invention;

FIG. 5 shows a sequence of steps for initializing an aggregation router according to an embodiment of the invention;

FIG. 6 shows a sequence of steps for activating the aggregation mode on a wireless router according to an embodiment of the invention; and

FIG. 7 illustrates an example of operational environment of the invention according to a “public transport” implementation scenario.

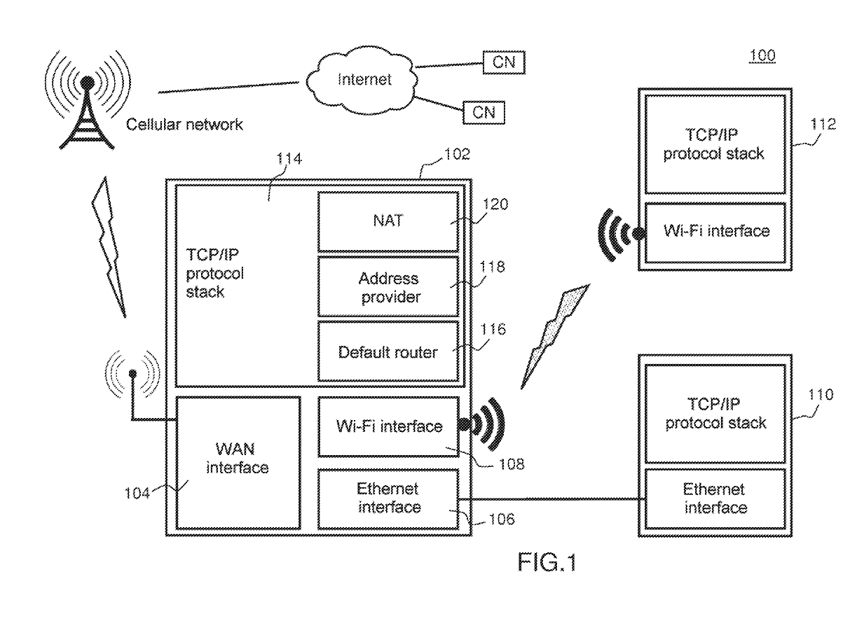

### DETAILED DESCRIPTION OF THE INVENTION

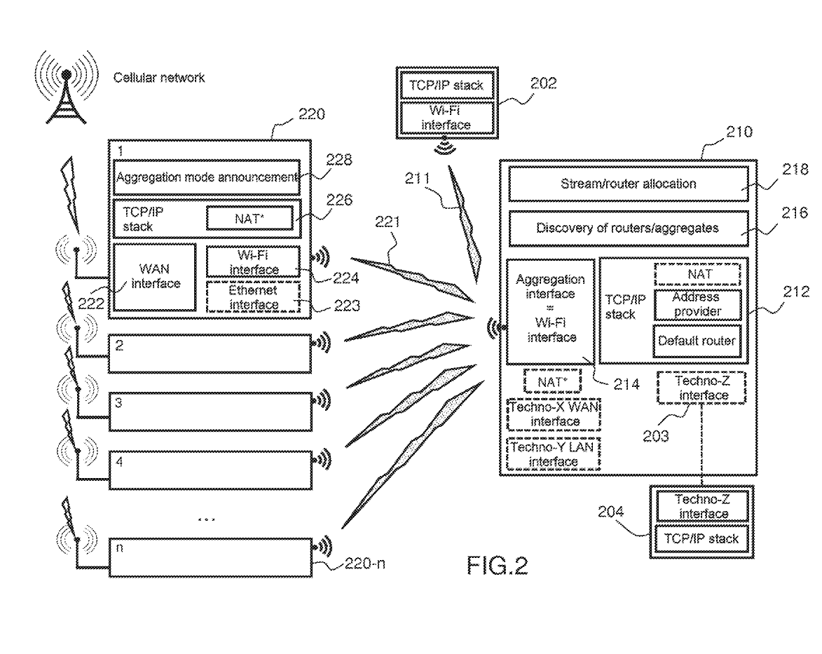

Reference is made to FIG. 2 which illustrates a communication environment in an IP network using an aggregation router (210) in an embodiment of the invention using the Wi-Fi technology.

In this configuration, one or more wireless routers (220 to 220-n), called aggregate routers communicate in Wi-Fi mode (221) with the aggregation router (210) via their respective Wi-Fi interface. In the example described, a user equipment item (202) which communicates with the aggregation router (210) in Wi-Fi mode (211) will be able to communicate with its correspondent or correspondents in the IP network by benefiting from a greater bandwidth corresponding to the aggregate bandwidth of the different wireless routers (220 to 220-n).

The bandwidth aggregation is obtained by the distribution on the different aggregate wireless routers of the different datastreams from the user terminals to the IP network.

For example, if a user terminal has 3 datastreams, each of these streams can be associated with a different aggregate wireless router, and thus, each stream can benefit from the maximum bandwidth of a WAN interface, whereas, if all the streams were to transit via the same WAN interface, without “aggregation” of the wireless routers, each stream could have on average only a third of the bandwidth of a WAN interface, all the streams then transiting to a single wireless router.

The maximum bandwidth theoretically available for the streams from the user terminals to the IP network is the minimum value between (1) the bandwidth of the LAN network to which the user terminals and the aggregation router are connected, and the LAN interfaces of the aggregate wireless routers, and (2) the sum of the bandwidths of the WAN interfaces of the aggregate wireless routers.

The aggregation router (210) is composed of a single network interface, called aggregation interface (214), on which it is configured via a protocol module (212) as access router, that is to say default router and address provider. In the example of FIG. 2, the aggregation router configures its Wi-Fi aggregation interface in access point (AP) mode.

More generally, for any LAN technology associated with a star-type topology, the aggregation router configures its aggregation interface to operate as root node of the topology. The aggregation interface is used to intercept the datastreams from the user terminals (202) and redirect these streams to the Wi-Fi interfaces of the aggregate routers (220 to 220-n).

The aggregation router (210) also comprises a module (216) for discovering the wireless routers (220 to 220-n) which operate in aggregation mode and are connected to the Wi-Fi aggregation interface (214) of the aggregation router.

The aggregation router (210) also comprises a module (218) for allocating the datastreams from the user terminals (202) to the various discovered aggregate wireless routers (220 to 220-n) connected to the aggregation interface (214) of the aggregation router.

The aggregation router (210) can also comprise additional interface blocks (203) to allow the aggregation router to take over datastreams from terminals connected to these additional interfaces 203 and dispatch them to the aggregate routers.

To facilitate the description of the invention, hereinbelow, just one aggregate wireless router (220) is described in more detail, but the person skilled in the art can extend the principles to a plurality of aggregate wireless routers (220 to 220-n) in communication with the aggregation router (210).

An aggregate wireless router (220) comprises a WAN interface (222) connected to the Internet or to an IP network, a LAN interface of Wi-Fi type (224) configured as a terminal, that is to say applying neither the default router function nor the address provider function, and they can be connected to the aggregation interface (214) of an aggregation router (210). The aggregate wireless router further comprises a protocol module (226) allowing the activation of the IP routing between the WAN interface (222) and the Wi-Fi interface (224) with the systematic use of an address translation NAT mechanism (referenced NAT* in the figure) for any IP traffic routed between its LAN and WAN interfaces. The aggregate wireless router (220) further comprises an announcement module (228) which allows the router to announce itself as being configured in aggregation mode to allow an aggregation router (210) to discover that the wireless router is operating according to the aggregation mode.

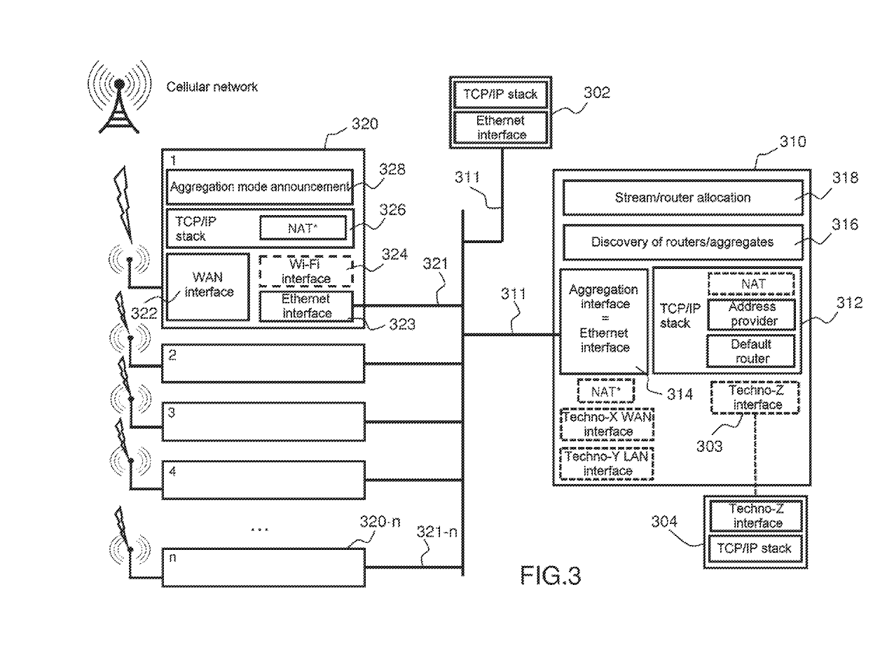

The aggregate wireless router can also comprise other LAN interfaces (223), of Ethernet type, for example, as is detailed with reference to FIG. 3. The technologies commonly used for the LAN interfaces are, in particular, Ethernet (IEEE 802.3) and Wi-Fi (IEEE 802.11 family of standards).

FIG. 3 illustrates an environment for high-bitrate communication by aggregation of wireless routers (320 to 320-n) in a case of use of the Ethernet technology.

In this configuration, the topology is of bus or “mesh” type in which each node (301, 311, 321, 321-n) on the LAN network can communicate directly with another node on the same LAN.

In the example described, one or more wireless routers (320 to 320-n), called aggregate routers, communicate in Ethernet mode (321) with an aggregation router (310) via their respective Ethernet interface. A user equipment item (302) which communicates with the aggregation router (310) in Ethernet mode over the LAN network (301, 311) will be able to communicate with its correspondent or correspondents in the IP network by benefiting from a greater bandwidth corresponding to the aggregate bandwidth of the different wireless routers (320 to 320-n).

The aggregation router (310) comprises an Ethernet network interface, called aggregation interface (314), on which it is configured via a protocol module (312) as an access router, that is to say as default router and address provider. As for any LAN technology associated with a “bus” or “mesh” type topology, the Ethernet interface does not require particular configuration to intercept the datastreams from user terminals and redirect them to the Ethernet interfaces of the aggregate routers.

An aggregate wireless router (320) in an Ethernet operating mode comprises a WAN interface (322) connected to the Internet or to an IP network, an Ethernet LAN interface (323) being able to be connected to the Ethernet aggregation interface (314) of an aggregation router (310). The aggregate wireless router further comprises a protocol module (326) allowing the activation of the IP routing between the WAN interface (322) and the Ethernet interface (323) with the systematic use of an address translation NAT mechanism (referenced NAT* in FIG. 3). The aggregate wireless router (320) further comprises an announcement module (328) which allows the router to announce itself as being in aggregation mode to allow an aggregation router (310) to discover that the wireless router is operating according to the aggregation mode.

The aggregation router (310) also comprises a module (316) for discovering wireless routers (320 to 320-n) which are operating in aggregation mode and which are connected to the Ethernet aggregation interface (314) of the aggregation router.

The aggregation router (310) also comprises a module (318) for allocating datastreams from the user terminals (302) to the various discovered aggregate wireless routers (320 to 320-n) connected to the aggregation interface (314) of the aggregation router.

The aggregation router (310) can further comprise additional interface blocks (303) for non-aggregation mode communications with user terminals (304).

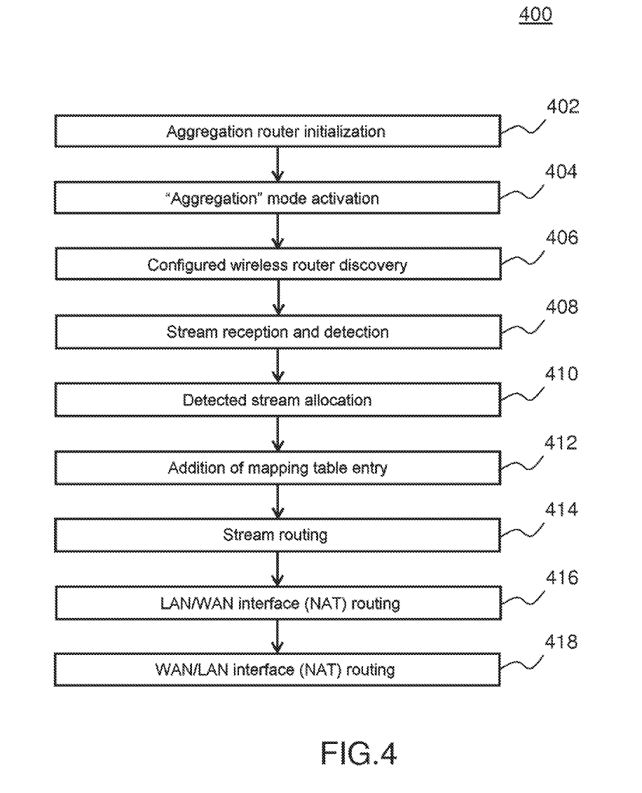

FIG. 4 shows a sequence of the steps (400) applied by the device of the invention that make it possible to route a datastream from a user terminal to the IP network by benefiting from a greater bandwidth corresponding to the aggregate bandwidth of different wireless routers. The method begins with a step (402) of initialization of the aggregation router and a step (404) of activation of the aggregation mode on one or more wireless routers. The method then makes it possible (step 406) to discover wireless routers which are configured in aggregation mode. In a next step (408), the method allows the detection and the reception of a new stream transmitted by a user terminal. Since the aggregation router acts as default router on its aggregation interface, it is used by the user terminals connected to the LAN of the aggregation interface as default router. Each user terminal therefore transmits any stream outgoing to a correspondent in the Internet to the aggregation interface of the aggregation router.

The next step (410) consists in allocating the received stream to one of the aggregate wireless routers. The wireless routers configured in aggregation mode can be selected by the aggregation router according to certain criteria. The aggregation router uses the list of the aggregate routers selected to distribute, allocate the datastreams from the user terminals connected to the aggregation interface to the different aggregate routers. Several distribution algorithms can be used, such as, for example, those targeting:
balancing of the number of streams transiting on each of the aggregate routers. When a new stream from a user terminal connected to the aggregation interface is received by the aggregation router, the latter allocates this stream to the aggregate router managing the smallest number of streams. In this embodiment, the aggregation router counts the number of streams allocated to each aggregate router;
balancing of the bandwidth consumed by the streams on each of the aggregate routers. When a new stream from a user terminal connected to the aggregation interface is received by the aggregation router, the latter allocates this stream to the aggregate router having the smallest aggregate bandwidth consumed by the streams already in progress. In this embodiment, the aggregation router counts, for each of the aggregate routers, the total bandwidth consumed by the streams allocated to said aggregate router;
balancing according to the bandwidth available on each of the aggregate routers. When a new stream from a user terminal connected to the aggregation interface is received by the aggregation router, the latter allocates this stream to the aggregate router having, on its WAN interface, the greatest available bandwidth. In this embodiment, the aggregation router counts, for each of the aggregate routers, the bandwidth available on the WAN interface of said aggregate router, the latter for example being able to be estimated by subtracting, from the maximum bandwidth of the WAN interface, the total bandwidth consumed by the streams allocated to said aggregate router and transiting on its WAN interface.

The person skilled in the art will understand that other algorithms can be implemented to distribute the datastreams to the aggregate wireless routers.

In a next step (412), the method makes it possible to save the association created between the stream and the selected aggregate router. The module (218, 318) for allocating streams to the aggregate routers is responsible for maintaining a mapping table indicating, for each stream, the aggregate router which is assigned to it. An entry in the table can for example identify a new stream in the form of a set of parameters deriving from the protocol headers contained in the datastream, such as, for example, the set {source IP address, destination IP address, source port, destination port}. The associated aggregate router can be identified according to a router identification parameter received from the latter in its announcement messages, such as, for example, its IP address or its MAC address on the aggregation interface.

In a next step (414), the method makes it possible to route all the data packets associated with a received stream to the aggregate router selected according to the corresponding entry in the mapping table. When a new stream which is not already listed in the mapping table is detected, the stream allocation module selects the aggregate router to be used for this new stream, according to the algorithm implemented and adds a new entry in its mapping table. Once this entry is created, all the data packets associated with this same stream are automatically routed to the corresponding aggregate router. More specifically, the aggregation router transmits said data packets over its aggregation interface by specifying the MAC address of the aggregate router as destination address in the header of the MAC frame of the message.

In a next step (416), the method makes it possible to route the data packets outgoing to the IP network from the aggregate router. The outgoing packets of the data stream are received on the LAN interface of the aggregate router and modified according to the NAT-systematic mechanism (NAT*) described previously before being transmitted over the WAN interface. This mechanism makes it possible to ensure that all the outgoing data packets will have, as source-IP address, the address of the WAN interface of the aggregate router. Consequently, the “incoming” data packets transmitted in response to “outgoing” data packets are routed to the WAN interface of the aggregate router managing said stream. Advantageously, this systematic network address translation NAT mechanism makes it possible to ensure that the “incoming” and “outgoing” packets of one and the same datastream all transit through the same aggregate router.

The next step (418) illustrates the reception of incoming packets of a datastream received at the WAN interface of the aggregate router. The incoming packets are modified according to the NAT-systematic mechanism (NAT*) in order to replace the destination IP address contained in the packet, i.e. that of the WAN interface, with the IP address of the user terminal that is the recipient of the stream. After replacement, the packet is transmitted over the LAN interface of the aggregate router. If the LAN has a star-type topology, case of the Wi-Fi technology with the aggregation interface configured as access points, the “incoming” packets are routed via the aggregation router and via its aggregation interface to the recipient user terminal. If the LAN has a “bus” or “mesh” type topology, case of the Ethernet technology, the “incoming” packets are routed directly from the aggregate router to the user terminal if the latter is connected to said LAN.

FIG. 5 details the sequence of steps (500) for initializing an aggregation router according to an embodiment of the invention. The aggregation router configures its aggregation interface for it to operate as access router. This operation comprises, at linked level (step 502), the configuration of the interface in Wi-Fi access point mode if the interface is of Wi-Fi type (or, generally, the configuration of the interface as root node for any other LAN technology associated with a star-type topology), and at the network level (step 504), the configuration of the interface as default router and address provider on the LAN.

In a next step (506), the aggregation router generates one or more discovery messages on its aggregation interface in order to prompt the transmission of announcement messages by wireless routers configured in aggregation mode and connected to the aggregation interface of the aggregation router. The aggregation router continually updates a list of the aggregate wireless routers discovered. According to the variant implementations, an aggregation router can transmit, regularly, for example periodically, discovery messages on its aggregation interface in order to check and update if necessary the list of the wireless routers configured in aggregation mode, called “list of the aggregate routers”, connected to its aggregation interface. The aggregation router uses the list of the aggregate routers to distribute and allocate the data streams from the user terminals to the different aggregate routers.

The list of the aggregate routers selected can change over time, depending on where the new wireless routers in aggregation mode are discovered on the LAN or other aggregate routers disappear for example through deactivation of the aggregation mode on a wireless router.

In a variant of the invention, the aggregation router can assess the availability and the quality of the WAN connection of a wireless router in aggregation mode that has been discovered, before considering it as a usable router to be added to the list of aggregate routers. The check on the availability of connectivity to the WAN interface can be performed by the aggregation router by sending a data packet to a destination in the Internet and awaiting the response in return. One way to proceed may be with the “ping” application.

The assessment of the quality can be made on certain quality parameters of a WAN connection, such as the latency for example. The aggregation router can proceed with an exchange of packets with a recipient in the Internet network in order to measure the round trip time (RTT) and deduce a latency therefrom, for example ½ RTT.

The assessment of the quality can be made on other parameters of quality of the WAN connection, such as the strength of the signal received on the WAN interface. The aggregation router can use a discovery message by including therein a suitable option for invoking one or more quality parameters, which will be included in the announcement message returned by the aggregate router to be selected.

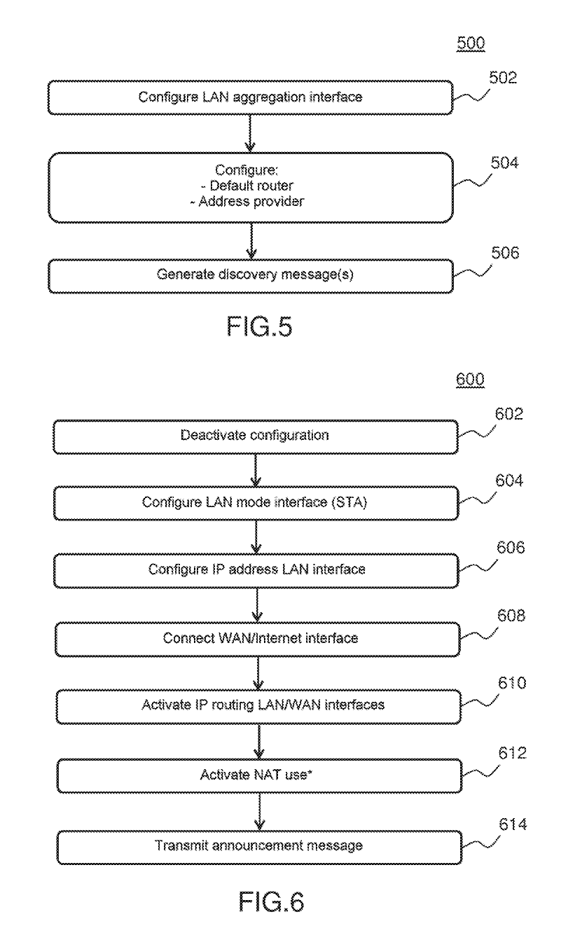

FIG. 6 details the sequence (600) of the steps for activating the aggregation mode on a wireless router according to an embodiment of the invention.

A first step (602) consists in deactivating a possible existing configuration on the wireless router. It may involve deactivating an earlier configuration of “default router” type or of “address provider” type or any IP address configuration, of IPv4 and/or IPv6 type for example.

Advantageously, the “aggregation” mode can be configured statically on the wireless routers, and in which case they operate systematically according to this mode, or, alternatively, the “aggregation” mode can be configured dynamically, for example directly by the user of the device. As an example, in the case where the wireless router is a smartphone, the “aggregation” mode can be activated manually by the user from a smartphone configuration interface.

Advantageously, a wireless router can operate according to the aggregation mode on just one or several of its LAN interfaces in parallel. In a variant implementation, the configuration of the aggregation mode on the wireless router can include a list of the LAN interfaces for which the aggregation mode is used.

If the LAN interface is of Wi-Fi type, the method makes it possible to configure it in station terminal mode “STA” (step 604) and to proceed with the attachment of this Wi-Fi LAN interface to the Wi-Fi aggregation interface (itself configured in access point mode) of the aggregation router, in order to allow the Wi-Fi connection to be set up between the wireless router (via its LAN interface) and the aggregation router (via its aggregation interface).

To allow the wireless router in Wi-Fi station terminal mode to detect the presence of the aggregation router acting as Wi-Fi access point, the Wi-Fi interface of the aggregation router can be associated with a Wi-Fi network identifier (e.g. an ESSID) known to the wireless router so that the latter recognizes, by virtue of this identifier announced by the aggregation router on its Wi-Fi interface, that it is indeed the aggregation router targeted. Thus, the wireless router connects its Wi-Fi LAN interface to the Wi-Fi access point formed by the Wi-Fi aggregation interface of the aggregation router.

Then, the method makes it possible to automatically configure (step 606) on the LAN interface a new IP address, which can be an IPv4 and/or IPv6 address. The address configuration can be of stateful or stateless type. In a next step (608), the WAN interface of the router is connected to the Internet network.

Then (step 610), the method makes it possible to activate the IP routing (IPv4 and/or IPv6) between the WAN interface and the LAN interface, and activate (step 612) the systematic use of the address translation mechanism NAT* for any IP traffic routed between its LAN and WAN interfaces. The systematic use of NAT differs from the traditional use of this mechanism, which normally is used only when the addressing space on the LAN interface cannot be routed over the WAN interface. In the method of the present invention, the systematic NAT* mechanism means that the address translation is used even when the addresses used on the LAN interface can be routed over the WAN interface. Thus, for example, the NAT* mechanism is used even if the LAN interface is configured with IPv4 and/or IPv6 addresses that are overall routable in the Internet network that can be reached via the WAN interface. Advantageously, this systematic configuration of the NAT mechanism makes it possible to ensure that the packets associated with a bidirectional datastream all transit uplink and downlink via the same WAN interface.

In a next step (614), the method allows the transmission of an announcement message on each of its LAN interfaces associated with the “aggregation” mode. The announcement message transmitted over a LAN interface contains at least one identifier of the wireless router, such as, for example, the MAC address or the IP address of the LAN interface.

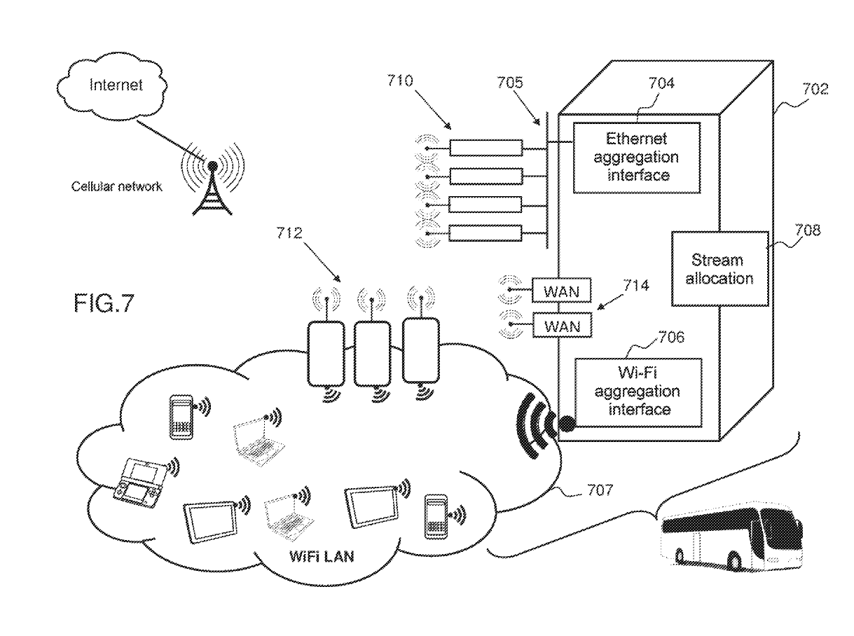

FIG. 7 illustrates an example of operational environment of the invention according to a “public transport” implementation scenario.

In this variant implementation, one and the same aggregation router can be equipped with several (two or more) aggregation interfaces, each interface being associated with a different LAN network. In the example illustrated, an aggregation router (702) is equipped with a first aggregation interface of Wi-Fi type (706) and a second aggregation interface of Ethernet type (704).

In this configuration, the distribution of the streams implemented by the stream allocation module (708) of the aggregation router can be done either:
in “separate allocation” mode in which the aggregation router independently and separately manages the distribution of the streams to each of its aggregation interfaces. The streams from user terminals associated with an aggregation interface can transit only through the aggregate routers visible on this same aggregation interface.
In “joint allocation” mode in which the aggregation router commonly and jointly manages the distribution of the streams to all of its aggregation interfaces. Thus, a stream from a user terminal associated with a first aggregation interface may possibly be allocated to an aggregate router which is itself connected to another aggregation interface of the same aggregation router.

This variant is illustrated in FIGS. 2 and 3 in the form of the optional “Techno-Y LAN interface” module that can serve as additional aggregation interface on the aggregation router (210, 310).

In another variant implementation, that can coexist with the preceding variant, one and the same aggregation router can be equipped with one or more WAN interface(s) (714) in addition to its aggregation interface or interfaces, for example two WAN interfaces of the same type or of different types, e.g. 2G/3G/4G.

Advantageously, in this variant implementation, the aggregation router can also be configured as a wireless router operating according to the “aggregation” mode on its WAN interface or interfaces (714) by using, as wireless router LAN interface, one of the aggregation interfaces (704, 706). In this configuration, the systematic NAT mechanism (NAT*) is activated by the streams from the LAN interface and routed to the WAN interface. This variant is illustrated in FIGS. 2 and 3 in the form of the optional “Techno-X WAN interface” and “NAT*” modules. In this variant, the aggregation router (702) can jointly manage the distribution of the streams to its WAN interface or interfaces (714) and to the aggregate routers (710, 712) connected to its aggregation interface or interfaces (704, 706). Thus, a stream from a user terminal associated with an aggregation interface can possibly be allocated to a WAN interface of the aggregation router acting as an aggregate router.

In another variant implementation that can coexist with the preceding variants, the aggregation router can also act as user terminal, and be the source of datastreams which are then processed similarly to those originating from other user terminals connected to aggregation interfaces of the aggregation router.

In another variant implementation that can coexist with the preceding variants, the aggregation router (702) can be equipped with one or more additional LAN interface(s) on which the equipment item acts also as traditional access router without operating as aggregation router on this interface, that is to say without transmitting announcement messages over its interfaces. In this configuration, any data stream from terminals connected to these interfaces can be processed similarly to streams originating from other user terminals, connected to aggregation interfaces of the aggregation router. This variant is illustrated in FIGS. 2 and 3 in the form of the optional “Techno-Z interface” and “NAT” modules on the aggregation router.

In another variant implementation, the WAN interfaces can be of wired type.

Thus, the present description illustrates a preferential implementation of the invention, but is not limiting. An example has been chosen to allow a good understanding of the principles of the invention, and a concrete application, but it is in no way exhaustive and should allow the person skilled in the art to add modifications and variant implementations while retaining the same principles.

The invention can be implemented from hardware and/or software elements. It can be available as computer program product on a computer-readable medium. The medium can be electronic, magnetic, optical, electromagnetic or be of infrared type. Such media are, for example, semiconductor memories (Random Access Memory RAM, Read-Only Memory ROM), tapes, diskettes or magnetic or optical discs (Compact Disc—Read Only Memory (CD-ROM), Compact Disc—Read/Write (CD-R/W) and DVD).

1. A device for wireless communication in an IP network having a plurality of wireless routers capable of routing datastreams, each router having at least one LAN interface and a WAN interface, the device being coupled to the plurality of wireless routers, and comprising:
a router discovery module for identifying, among the plurality of wireless routers, any router which applies, according to an aggregation mode, the aggregation mode allowing a router, being an aggregate router, to systematically route any IP traffic between its LAN and WAN interfaces according to a network address translation (NAT) mechanism;
a single network interface, being an aggregation interface, configured to receive datastreams from user terminals and to transmit the received datastreams to aggregate routers; and
a stream allocation module capable of selecting, for a datastream received from a user terminal, one or more aggregate routers among the discovered aggregate routers and of distributing the datastream to said one or more aggregate routers.

2. The device as claimed in claim 1, comprising a configuration module for configuring said aggregation interface as default router and address provider.

3. The device as claimed in claim 1, wherein the aggregate router discovery module is capable of generating invocation messages to the plurality of wireless routers and of receiving in response aggregate router announcement messages.

4. The device as claimed in claim 1, wherein the stream allocation module applies a distribution algorithm to balance the number of streams transiting on each of said aggregate routers.

5. The device as claimed in claim 1, wherein the stream allocation module applies a distribution algorithm to balance the bandwidth consumed by the streams on each of the aggregate routers.

6. The device as claimed in claim 1, wherein the stream allocation module applies a distribution algorithm to balance the bandwidth available on each of the aggregate routers.

7. The device as claimed in claim 1, wherein the aggregation interface is a LAN interface of Ethernet or Wi-Fi type.

8. The device as claimed in claim 1, wherein the aggregation interface is a LAN interface of Wi-Fi type configured in access point mode.

9. The device as claimed in claim 1, comprising at least one second aggregation interface configured to receive datastreams from user terminals and to transmit each received datastream to the aggregate router which is allocated to it.

10. The device as claimed in claim 9, wherein the stream allocation module applies an algorithm for distributing streams in joint allocation mode to distribute the streams to all of its aggregation interfaces.

11. The device as claimed in claim 9, wherein the stream allocation module applies an algorithm for distributing distribution of the streams in separate allocation mode to distribute the streams to each of its aggregation interfaces.

12. The device as claimed in claim 1, further comprising one or more WAN interfaces, and wherein the stream allocation module applies an algorithm to distribute the streams over the one or several more WAN network interfaces and over its aggregation interface or interfaces.

13. The device as claimed in claim 1, further comprising one or more network interfaces to transmit datastreams in user terminal mode.

14. The device as claimed in claim 1, further comprising one or more LAN network interfaces for receiving datastreams from user terminals, and wherein the stream allocation module applies an algorithm to distribute said streams over the one or more WAN network interfaces and over its aggregation interface or interfaces.

15. The device as claimed in claim 1, wherein said aggregate router comprises a configuration module for activating the network address transfer (NAT) mechanism in systematic use, and an announcement message generation module for transmitting announcement messages.

16. The device as claimed in claim 15, wherein the announcement messages are transmitted in response to invocation messages.

17. The device as claimed in claim 1, wherein the LAN interface of said aggregate router is of Wi-Fi type configured in station terminal (STA) mode and systematically using a network address translation (NAT) mechanism for any traffic routed between its Wi-Fi and WAN interfaces.

18. A method for operating wireless communications in an IP network having a plurality of wireless routers capable of routing datastreams, each router having at least one LAN interface and a WAN interface, the method comprising:
receiving a datastream from a user terminal;
identifying, among the plurality of wireless routers, any router which operates according to an aggregation mode, the aggregation mode allowing the router, being an aggregate router, to route any IP traffic between its LAN and WAN interfaces systematically according to a network address translation (NAT) mechanism.
selecting one or more aggregate routers among the identified aggregate routers;
distributing the received datastream over said one or more selected aggregate routers; and
transmitting the datastream to said one or more selected aggregate routers.

19. A device as claimed in claim 1, comprising means to apply a method for operating wireless communications in an IP network having a plurality of wireless routers capable of routing datastreams, each router having at least one LAN interface and a WAN interface, the method comprising:
receiving a datastream from a user terminal;
identifying, among the plurality of wireless routers, any router which operates according to an aggregation mode, the aggregation mode allowing the router, being an aggregate router, to route any IP traffic between its LAN and WAN interfaces systematically according to a network address translation (NAT) mechanism;
selecting one or more aggregate routers among the identified aggregate routers;
distributing the received datastream over said one or more selected aggregate routers; and
transmitting the datastream to said one or more selected aggregate routers.

20. A computer program product, said computer program comprising code instructions to perform the steps of the method as claimed in claim 18, wherein said program is run on a computer.
